(19) United States
(12) Patent Application Publication
(10) Pub. No.: US 2020/0016931 A1
(43) Pub. Date: Jan. 16, 2020

(54) Axle Assembly

(71) Applicant: Dana Heavy Vehicle Systems Group, LLC, Maumee, OH (US)

(72) Inventor: Lucas A. Balistreri, Bowling Green, OH (US)

(21) Appl. No.: 16/033,734

(22) Filed: Jul. 12, 2018

(51) Int. Cl. B60B 35/16; F16H 57/04; B60B 35/14; B60B 35/12

(52) U.S. Cl. CPC B60B 35/16; F16H 57/0457; B60B 2900/561; B60B 35/14; B60B 35/122; F16H 57/0495

(57) ABSTRACT

An axle assembly includes at least one axle. An axle housing having a center portion and at least one arm portion that extends from the center portion is provided: The at least one arm portion receives the at least one axle. A conduit assembly directs lubricant from the center portion to the at least one arm portion. The conduit assembly includes one or more restrictions that impede a flow of the lubricant in the conduit assembly.

### BACKGROUND

The invention relates to an axle assembly. More particularly, the invention relates to an axle assembly having a conduit assembly.

The drivetrain of a vehicle can suffer from efficiency losses under certain conditions. These losses can be due, at least in part, to the amount of lubricant in the axle assembly. Therefore, to reduce efficiency losses, it would be advantageous manage the amount of lubricant in the axle assembly.

### SUMMARY

Embodiments of an axle assembly are provided.

In an embodiment, the axle assembly comprises at least one axle. An axle housing having a center portion and at least one arm portion that extends from the center portion is provided. The at least one arm portion receives the at least one axle. A conduit assembly directs lubricant from the center portion to the at least one arm portion. The conduit assembly comprises one or more restrictions that impede a flow of the lubricant in the conduit assembly.

In some embodiments, a portion of the conduit assembly disposed within the center portion is curved and extends in a downward direction toward an opening in the at least one arm portion.

In some embodiments, the conduit assembly comprises a first portion and a second portion. In an embodiment, the first portion is configured to receive lubricant splashed or sprayed by a ring gear and the one or more restrictions being provided in second portion. In another embodiment, the second portion directs the lubricant through the arm portion such that at least a portion of a flow of lubricant through the second portion is in a direction which is parallel to a direction in which the arm portion extends. In some embodiments, another portion of the flow of lubricant directed through the second portion is in a direction which is perpendicular to the direction in which the arm portion extends.

In some embodiments, the one or more restrictions are provided in a portion of the conduit assembly which is disposed within the arm portion. In an embodiment, the portion of the conduit assembly which is disposed within the arm portion extends from a first side of the arm portion toward a second side of the arm portion.

In some embodiments, the conduit assembly comprises a first portion and a second portion. The first portion is connected to the second portion via a coupling.

In some embodiments, the one or more restrictions comprises a plurality of bends.

In some embodiments, at least one restriction of the one or more restrictions is U-shaped.

In some embodiments, the conduit assembly comprises an end portion having an end for delivering lubricant to the arm portion. In an embodiment, the end defines an opening. In another embodiment, the end portion has a curved section which extends in a downward direction. In some embodiments, the axle assembly further comprises a cap secured to the end portion. In one such embodiment, the cap defines an opening. In an embodiment, the opening is of a diameter which is less than a diameter of a portion of the end portion.

### BRIEF DESCRIPTION OF THE SEVERAL VIEWS OF THE DRAWING

The above, as well as other advantages of the present invention will become readily apparent to those skilled in the art from the following detailed description when considered in the light of the accompanying drawings in which:

FIG. 1 is a perspective view of an axle assembly in accordance with the invention;

FIG. 2 is a partial exploded perspective view of the axle assembly of FIG. 1;

FIG. 3 is a sectional view of the axle assembly of FIG. 1 with lubricant removed from certain portions for clarity

FIG. 4 is a top view of a portion of FIG. 2;

FIG. 5 is a sectional view of a portion of another embodiment of the axle assembly;

FIG. 6 is a view of an embodiment of a portion of a conduit assembly; and

FIG. 7 is a view of another embodiment of a portion of the conduit assembly.

### DETAILED DESCRIPTION

It is to be understood that the invention may assume various alternative orientations and step sequences, except where expressly specified to the contrary. It is also to be understood that the specific assemblies and methods illustrated in the attached drawings, and described in the following specification are simply exemplary embodiments of the inventive concepts. Hence, specific dimensions, directions or other physical characteristics relating to the embodiments disclosed are not to be considered as limiting, unless expressly state otherwise. Also, although they may not be, like elements in various embodiments may be commonly referred to with like reference numerals within this section of the application.

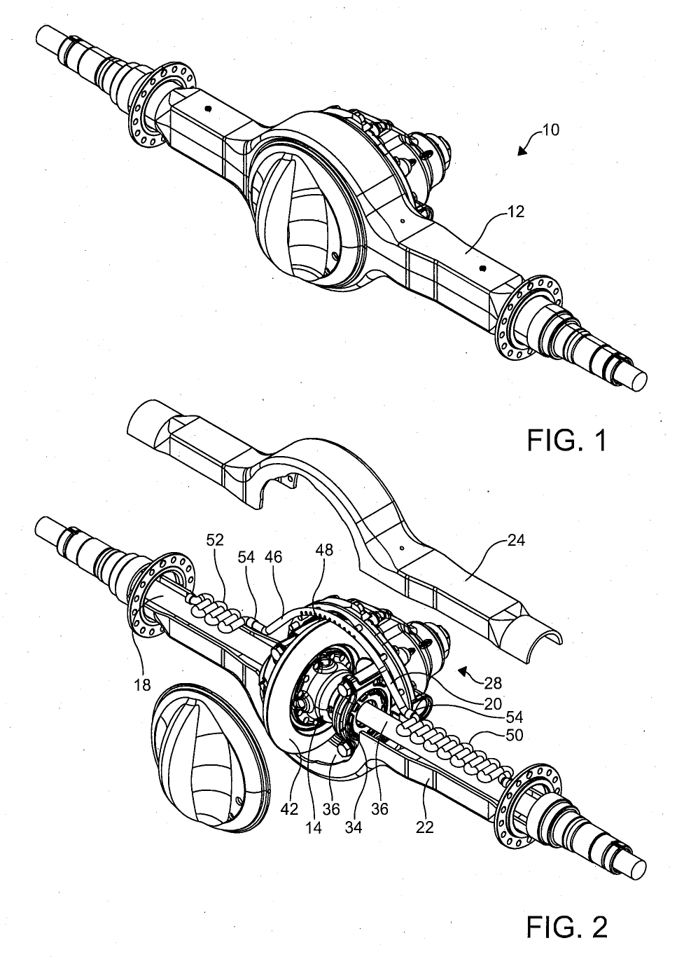

Various embodiments of an axle assembly 10 are described herein and illustrated in FIGS. 1-7. The embodiments of the axle assembly 10 described herein may have applications to certain vehicles (not depicted). For example, the axle assembly 10 described herein may have applications to commercial or off-highway vehicles. Also, it would be understood by one of ordinary skill in the art that these embodiments could have industrial, agricultural, locomotive, military, marine, or aerospace applications.

It should be appreciated that one or more axle assemblies 10 may be provided with the vehicle. Each axle assembly 10 may be provided as a portion of a drivetrain. The drivetrain may provide torque to one or more wheel assemblies (not depicted). Each wheel assembly may include a tire mounted on a wheel.

The axle assembly 10 may include an axle housing 12, a differential 14, at least one axle 16, 18, and a conduit assembly 20.

Certain components of the axle assembly 10 may be disposed within the axle housing 12. Additionally, the axle housing 12 may be utilized to mount the axle assembly 10 to the vehicle. The axle housing 12 may comprise components that are assembled together. For example, the axle housing 12 may comprise a first housing 22 and a second housing 24. The first housing 22 and the second housing 24 may be opposing halves of the axle housing 12. In an embodiment, the first housing 22 is disposed below the second housing 24. Thus, the first housing 22 may be a lower housing member and the second housing 24 may be an upper housing member. The first housing 22 and the second housing 24 may be assembled together. Assembly of the first housing 22 and the second housing 24 may be done in any suitable manner.

After assembly, the first housing 22 and the second housing 24 may define a center portion 26, a differential carrier portion 28, and one or more arm portions 30, 32. The center portion 26 may be disposed near the center of the axle housing 12. The center portion 26 may define a cavity 34 that receives at least a portion of the differential 14. The portion of the cavity below the differential 14 may at least partially define a sump 36. The sump 36 contains lubricant 37 that lubricates certain components of the of the axle assembly 10 such as, for example, the differential 14. In an embodiment, the lubricant 37 is oil or another suitable fluid.

The differential carrier portion 28 may be disposed adjacent the center portion 26. The differential carrier portion 28 may be coupled to the center portion 26 by fasteners or in another suitable manner. Components of the differential 14 may be disposed within the differential carrier portion 28.

The one or more arm portions 30, 32 extend from the center portion 26. In an embodiment, the one or more arm portions may comprise a first arm portion 30 and a second arm portion 32. The first arm portion 30 and the second arm portion 32 may extend from the center portion 26 in opposite directions. One or more portions of the first arm portion 30 may be formed in a unitary manner with the center portion 26. Also, one or more portions of the second arm portion 32 may be formed in a unitary manner with the center portion 26. Each arm portion 30, 32 has a length which is measured from the center portion to an outer end 39, 41 of the arm portion 30, 32. As illustrated best in FIGS. 1-3, the first arm portion 30 may be of a length which is greater than a length of the second arm portion 32.

In certain embodiments, each arm portion 30, 32 defines an arm cavity 38, 40. Preferably, each cavity 38, 40 receives an axle 16, 18 and a portion of a conduit assembly 20. Each arm portion 30, 32 and corresponding arm cavity 38, 40 may be positioned above the sump 36.

The differential 14 may be disposed in the axle housing 12. The differential 14 is configured to transmit torque to the wheel assemblies and permits rotation of the wheel assemblies at different velocities. An input yoke may enable coupling of the axle assembly to a torque source. For example, the input yoke (not depicted) may be coupled to a drive shaft (not depicted). The input yoke may be disposed on an input shaft. The input shaft may be rotatably supported by one or more bearings. The one or more bearings may be disposed on the differential carrier portion 28. Torque that is provided to the input yoke may be transmitted to a ring gear 42. Torque may be transmitted from the ring gear 42 to each axle 16, 18. Torque is transmitted from each axle 16, 18 to a corresponding wheel assembly.

Each axle 16, 18 has a first end that is coupled to the differential 14 to enable rotation of the axle 16, 18 via the differential 14. In certain embodiments, each axle 16, 18 rotates about an axis. Preferably, each axle 16, 18 extends through an arm cavity 38, 40. Each axle 16, 18 may rotate in an arm cavity 38, 40. The axle 16, 18 may also extend through an opening in the axle housing 12 to a second end. An axle flange (not depicted) may be provided at the second end of each axle 16, 18 to facilitate mounting of a wheel hub and/or a wheel assembly. An axle bearing (not depicted) may be provided to support rotation of an axle 16, 18. The axle bearing may be positioned between the first end and the second end of the axle. In certain embodiments, each axle bearing is disposed in an arm cavity 38, 40.

The ring gear 42 rotates about an axis. Rotation of the ring gear 42 displaces some of the lubricant 37 in the sump 36. Under certain conditions, it may desirable to direct some of the displaced lubricant 37 to other portions of the axle assembly 10 to lubricate other components of the axle assembly 10 and reduce the amount of the lubricant 37 in the sump 36. For example, when the vehicle is travelling at highway driving speeds, it may be desirable to reduce the amount of the lubricant 37 in the sump 36.

Lubricant 37 that is displaced from the sump 36 may be splashed or sprayed within the center portion 26 and received by the conduit assembly 20. Preferably, the conduit assembly 20 is positioned above the sump 36. The conduit assembly 20 directs lubricant 37 from the center portion 26 to at least one arm portion 30, 32. Preferably, the conduit assembly 20 directs lubricant 37 from the center portion 26 to the first arm portion 30 and the second arm portion 32. In certain embodiments, the conduit assembly 20 directs lubricant 37 through at least one arm portion 30, 32. Preferably, the conduit assembly 20 directs lubricant 37 through the first arm portion 30 and the second arm portion 32.

In these embodiments, a first portion 46 of the conduit assembly 20 is configured to receive lubricant 37 splashed and/or sprayed by the ring gear 42. In an embodiment, the first portion 46 may be hollow and cylindrical. In order to receive lubricant 37, one or more perforations 48 may be provided in the first portion 46 of the conduit assembly 20. Preferably, the first portion 46 of the conduit assembly 20 is at least partially disposed within the center portion 26. Also, it is preferred that the first portion 46 of the conduit assembly 20 is spaced apart from the ring gear 42 to avoid interference between differential 14 and the conduit assembly 20. In some embodiments, the one or more perforations 48 are provided in the first portion 46 of the conduit assembly 20 so that each perforation is located within the center portion 26 and adjacent a portion of the ring gear 42. In an embodiment, the one or more perforations 48 are located above the ring gear 42. In other embodiments, the one or more perforations 48 may be located in another position relative to the ring gear 42 to receive lubricant 37.

The first portion 46 of the conduit assembly 20 may extend along an interior surface of the center portion 26 toward at least one arm portion 30, 32. In certain embodiments, the first portion 46 of the conduit assembly 20 is curved and extends in a downward direction toward each arm portion 30, 32. In some embodiments, the first portion 46 of the conduit assembly 20 extends from the center portion 26 into at least one arm portion 30, 32. In these embodiments, the first portion 46 of the conduit assembly 20 may extend into each arm portion 30, 32 through an opening in each arm portion 30, 32. The opening in the arm portion 30, 32 is in fluid communication with the arm cavity 38, 40.

Preferably, the first portion 46 of the conduit assembly 20 is connected to additional portions 50, 52 of the conduit assembly 20 at a first end and a second end thereof. In certain embodiments, the first end is disposed within the first arm portion 30 and the second end is disposed in the second arm portion 32. The first portion 46 of the conduit assembly 20 may be connected to each additional portion 50, 52 of the conduit assembly 20 via separate couplings 54. For example, as illustrated in FIG. 2, the first portion 46 may be connected to a second portion 50 via a coupling 54. The coupling 54 may receive the first end of the first portion 46 and a first end of the second portion 50. However, in some embodiments (not depicted), the first portion and one or more of the additional portions of the conduit assembly may be formed in a unitary manner. For example, the first portion may be formed in a unitary manner with the second portion and a third portion.

It is preferred that the second portion 50 of the conduit assembly 20 and the third portion 52 of the conduit assembly 20 are each configured to slow the flow of the lubricant 37 through the conduit assembly 20 and deliver the lubricant 37 to separate arm portions 30, 32. To allow lubricant 37 to flow therethrough and deliver lubricant 37 to an arm portion 30, 32, the second portion 50 of the conduit assembly 20 and the third portion 52 of the conduit assembly 20 may be hollow. The second portion 50 of the conduit assembly 20 and the third portion 52 of the conduit assembly 20 may have other common features. For example, the second portion 50 and the third portion 52 may each be cylindrical. Thus, for certain embodiments of the axle assembly 10; only the second portion 50 of the conduit assembly 20 may be described below. It should be appreciated that the embodiments described below for the second portion 50 may be applicable to certain embodiments of the third portion 52 of the conduit assembly 20.

Preferably, the second portion 50 of the conduit assembly 20 is disposed in an arm portion 30, 32. Preferably, the second portion 50 is disposed entirely within an arm portion 30. In an embodiment, the second portion 50 may be disposed in the first arm portion 30. More particularly, the second portion 50 may be disposed in the arm cavity 38 of the first arm portion 30. When provided, the third portion 52 of the conduit assembly 20 is disposed in a separate arm portion 32. For example, when the second portion 50 is disposed in the first arm portion 30, the third portion 52 may be disposed in the arm cavity 40 of the second arm portion 32. In this embodiment, the second portion 50 may be disposed entirely within the first arm portion 30. Also, the third portion 52 may be disposed entirely within the second arm portion 32. As the first arm portion 30 may be of a length which is greater than the length of the second arm portion 32, the second portion 50 may be of a length which is greater than a length of the third portion 52. In this embodiment, the second portion 50 may be of a volume which is greater than a volume of the third portion 52. In other embodiments (not depicted), the second portion 50 may be of a length which is the same as or less than the length of the third portion 52.

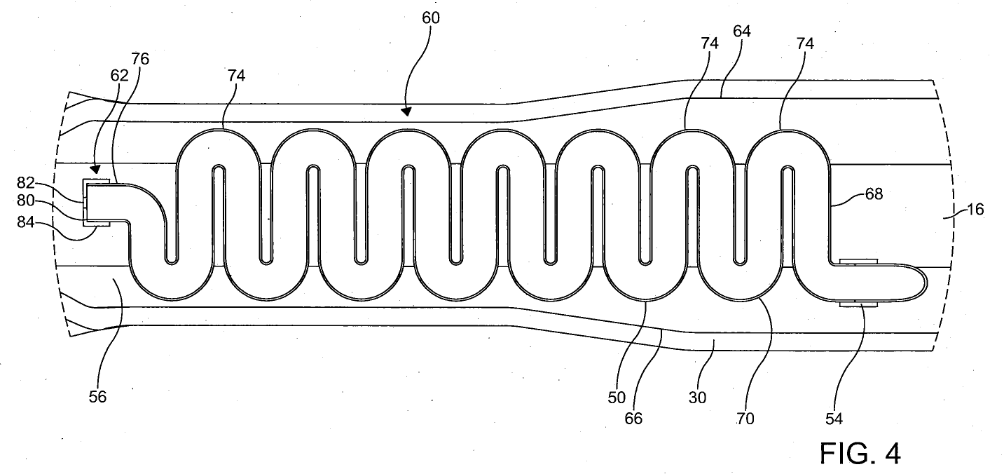

In the arm cavity 38, the second portion 50 is spaced apart from the axle 16 to avoid interference therewith. As illustrated best in FIG. 4, the second portion 50 may be disposed above the axle 16. However, in other embodiments (not depicted), the second portion may be disposed below the axle.

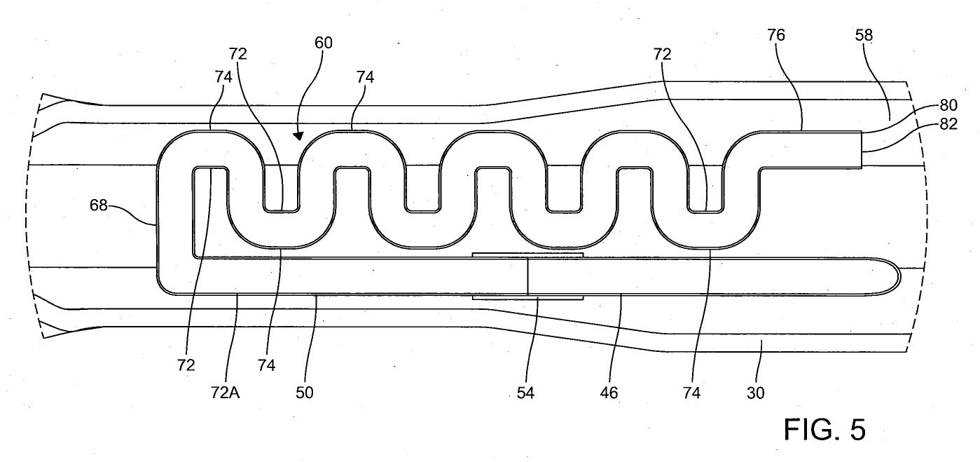

As noted above, the second portion 50 of the conduit assembly 20 is configured to slow the flow of lubricant through the conduit assembly 20 and deliver the lubricant 37 to the arm portion 30. For example, in an embodiment, like the one illustrated in FIG. 4, the second portion 50 delivers the lubricant 37 to an outer end section 56 of the arm portion 30, which is adjacent the outer end 39 of the arm portion 30. In other embodiments, like the one illustrated in FIG. 5, the second portion 50 delivers the lubricant 37 to an inner end section 58 of the arm portion 30, which is adjacent the center portion 26. In these embodiments, at least a portion of the second portion 50 extends toward the outer end section 56 of the arm portion 30.

When the vehicle is travelling at highway driving speeds, it may be desirable to reduce the amount of lubricant 37 in the sump 36 so that drag on the ring gear 42 is reduced and the efficiency of the axle assembly 10 is improved. To reduce the volume of the lubricant 37 in the sump 36, it may be desirable to deliver lubricant 37 to the conduit assembly 20 and delay the return of the lubricant 37 to the sump 36. Preferably, the lubricant 37 is retained in the conduit assembly 20 for a predetermined period of time. To retain lubricant 37 in the conduit assembly 20, the flow of lubricant in the conduit assembly 20 is impeded. In these embodiments, one or more of restrictions 60, 62 are provided in the conduit assembly 20 to impede the flow of lubricant in the conduit assembly 20.

In some embodiments, it may be desirable that the one or more restrictions 60, 62 are provided in the second portion 50 and/or the third portion 52 of the conduit assembly 20. Thus, in certain embodiments, the one or more of restrictions 60, 62 are provided in at least one of the second portion 50 and the third portion 52 of the conduit assembly 20. However, in other embodiments (not depicted), one or more of restrictions may be provided in the first portion of the conduit assembly.

The one or more restrictions 60, 62 provided in the second portion 50 of the conduit assembly 20 may be similarly configured to the one or more restrictions 60, 62 provided in the third portion 52 of the conduit assembly 20. In certain embodiments (not depicted), the one or more restrictions 60, 62 provided in the second portion may not be similarly configured to the one or more restrictions provided in the third portion 52.

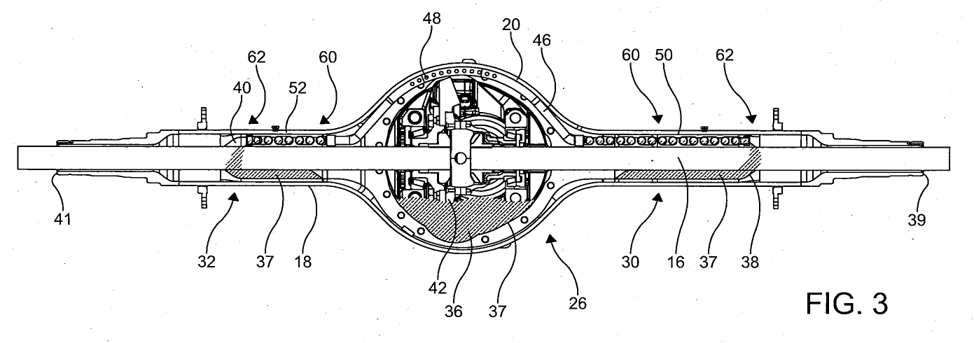

The number of restrictions 60, 62 provided in the second portion 50 of the conduit assembly 20 may be the same as the number of restrictions 60, 62 provided in the third portion 52 of the conduit assembly 20. In certain embodiments, like the one illustrated in FIG. 3, the number of restrictions 60, 62 provided in the second portion 50 is greater than the number of restrictions 60, 62 provided in the third portion 52. In other embodiments (not depicted), the number of restrictions 60, 62 provided in the second portion 50 is less than the number of restrictions 60, 62 provided in the third portion 52.

Referring back to FIG. 4, when one or more of restrictions 60 are provided in the second portion 50 of the conduit assembly 20, the second portion 50 of the conduit assembly 20 may extend from a first side 64 of the arm portion 30 toward a second side 66 of the arm portion 30 and/or from the second side 66 of the arm portion 30 toward the first side 64 of the arm portion 30. Additionally, one or more sections 68 of the second portion 50 may be provided in a perpendicular relationship with at least a portion of the arm portion 30. In some embodiments, one or more sections 68 of the second portion 50 may be provided in a perpendicular relationship with the axle 16 in the arm portion 30. In other embodiments, one or more sections 70 of the second portion 50 may be provided in an oblique relationship with at least a portion of the arm portion 30. In some embodiments, one or more sections 70 of the second portion 50 may be provided in an oblique relationship with the axle 16 in the arm portion 30.

In certain embodiments, like the one illustrated in FIG. 5, one or more sections 72, 72A of the second portion 50 may be provided in a parallel relationship with the at least a portion of the arm portion 30. In some embodiments, one or more sections 72, 72A of the second portion 50 may be provided in a parallel relationship with the axle 16 in the arm portion 30. In one such embodiment, the second portion 50 comprises a major section 72A which is provided in a parallel relationship with the axle 16 in the arm portion 30. In this embodiment, the major section 72A may extend from the coupling 54 toward the outer end of the axle housing 12. Also, in this embodiment, the second portion 50 may comprise a plurality of minor sections 72 which are each provided in a parallel relationship with the axle 16 in the arm portion 30. Each minor section of the plurality of minor sections 72 may be provided in a parallel relationship with the major section 72A. As illustrated, the major section 72A may be connected to a first minor section 72 via a section 68 of the second portion 50 which is provided in a perpendicular relationship with at least a portion of the arm portion 30 and the axle 16 in the arm portion 30.

In an embodiment, the one or more restrictions 60 may comprise a plurality of bends 74 in the conduit assembly 20. In this embodiment, each restriction 60 may correspond to a bend 74 in the conduit assembly 20. It should be appreciated that a bend may be curved portion provided the conduit assembly.

In some embodiments, each restriction of the one or more restrictions 60 may be configured to have a predetermined shape. In one such embodiment, at least one restriction of the one or more restrictions 60 may be shaped so that the at least one restriction comprises a curved portion. For example, in an embodiment, at least one restriction of the one or more restrictions 60 is U-shaped. In another embodiment, at least one restriction of the one or more restrictions 60 may have another shape that comprises a curved portion. For example, at least one restriction of the one or more restrictions 60 may be C-shaped or of another shape that comprises a curved portion. In other embodiments, at least one restriction of the one or more restrictions 60 may be shaped so that the restriction comprises one or more linear portions. For example, at least one restriction of the one or more restrictions may be V-shaped or of another shape that comprises at least one linear portion. In still other embodiments, at least one restriction of the one or more restrictions 60 may be of another shape.

In addition to impeding the flow of lubricant through the conduit assembly 20, the one or more of restrictions 60 help to direct the flow of lubricant in the conduit assembly 20 and through the corresponding arm portion 30, 32. Preferably, a flow of lubricant in the conduit assembly 20 is directed through the arm portion 30, 32 such that the lubricant 37 flows toward the outer end of the arm portion 30, 32 and/or the inner end of the arm portion 30, 32. For example, in the embodiment illustrated in FIG. 4, the flow of lubricant in the second portion 50 of the conduit assembly 20 is directed through the arm portion 30 toward the outer end of the arm portion 30. In another embodiment, like the embodiment illustrated in FIG. 5, the flow of lubricant in the second portion 50 of the conduit assembly 20 is directed through the arm portion 30 toward the outer end of the arm portion 30 and then toward the inner end of the arm portion 30.

In some embodiments, a flow of lubricant in the conduit assembly 20 is directed through the arm portion 30 such that the lubricant 37 flows in a direction which is parallel to the direction in which the corresponding arm portion 30, 32 extends. In other embodiments, a flow of lubricant in the conduit assembly 20 is directed through the arm portion 30, 32 such that the lubricant 37 flows in a direction which is perpendicular to the direction in which the corresponding arm portion 30, 32 extends. In still other embodiments, a flow of lubricant in the conduit assembly 20 may be directed through the arm portion 30, 32 in such a manner that the lubricant 37 flows in a direction which is oblique to the direction in which the corresponding arm portion 30, 32 extends.

After flowing through one or more restrictions 60, the lubricant 37 is directed to an end portion 76 of the conduit assembly 20. In the embodiments illustrated, the end portion 76 is provided as a section of the second portion 50 of the conduit assembly 20. In an embodiment, like the one illustrated in FIG. 7, the end portion 76 has a curved section 78. The curved section 78 may extend in a downward direction as is illustrated in FIG. 7. In this embodiment, the curved section 78 extends toward the first housing 22. In other embodiments (not depicted), the curved section may extend in an upward direction and toward the second housing. In other embodiments, like the ones illustrated in FIG. 5, the end portion 76 is linear.

Preferably, the end portion 76 has an end 80 for delivering lubricant 37 to the arm portion 30. However, in other embodiments (not depicted), the end portion may have an end that delivers lubricant to another portion of the axle assembly. In some embodiments, like the embodiments illustrated in FIG. 5, the end 80 defines an opening. In these embodiments, the opening may have a diameter which is equal to a diameter of the end portion 76. Alternatively, in an embodiment (not depicted), the opening may have a diameter which is greater than a diameter of the end portion.

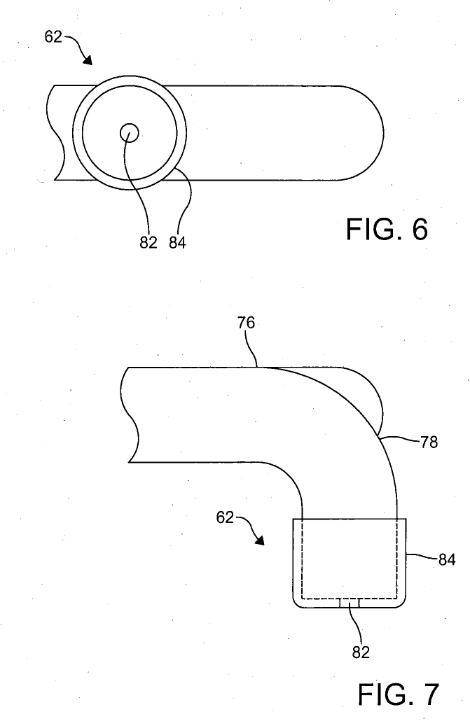

In other embodiments, like the one illustrated in FIGS. 4 and 6, the opening 82 is defined by a cap 84. When the opening 82 is defined by the cap 84, the opening 82 may have a diameter which is less than a diameter of the end portion 76. When the opening 82 is defined by the cap 84 and the opening 82 has a diameter which is less than a diameter of the end portion 76, the cap 82 may be a restriction 62 which impedes the flow of lubricant in the conduit assembly 20. In other embodiments (not depicted) where the opening is defined by a cap, the opening may have a diameter which is equal to the diameter of the end portion. The cap 84 is secured to the end portion 76. In an embodiment, the cap 84 is secured to the end portion 76 via an adhesive, threaded connection, or in another manner. In another embodiment (not depicted), the cap may be formed in a unitary manner with the end portion.

As illustrated, each opening 82 is spaced apart from the one or more perforations 48. It is also preferred that each opening 82 is positioned relative to the one or more perforations to allow lubricant 37 to flow from the one or more perforations 48 to the opening 82 under the influence of gravity. In an embodiment, the opening 82 is positioned in the arm portion 30, 32 so that it is at a height in the axle assembly 10 which is less than a height of the one or more perforations 48 in the axle assembly 10. Preferably, each opening 82 is positioned at a height in the axle assembly 10 which is less than a height of the one or more perforations 48 in the axle assembly 10. Positioning the opening as described above, allows lubricant 37 to be delivered to an arm portion 30, 32 without using a pump or another device. Also, it is preferred that each opening 82 is disposed in an arm portion 30, 32. Once lubricant 37 passes through the opening 82, it is delivered to the arm portion 30, 32 where it flows therefrom back to the center portion 26 and the sump 36.

From the foregoing detailed description, it will be apparent that various modifications, additions, and other alternative embodiments are possible. The embodiments discussed herein were chosen and described to provide the best illustration of the principles of the axle assembly and its practical application to thereby enable one of ordinary skill in the art to use the axle assembly in various embodiments and with various modifications as are suited to the particular use contemplated. As should be appreciated, all such modifications and variations are within the scope of the invention.

1. An axle assembly, comprising:
at least one axle;
an axle housing having a center portion and at least one arm portion that extends from the center portion, the at least one arm portion receiving the at least one axle; and
a conduit assembly that directs lubricant from the center portion to the at least one arm portion, the conduit assembly comprising one or more restrictions that impede a flow of the lubricant in the conduit assembly.

2. The axle assembly of claim 1, wherein a portion of the conduit assembly disposed within the center portion is curved and extends in a downward direction toward an opening in the at least one arm portion.

3. The axle assembly of claim 1, wherein the conduit assembly comprises a first portion and a second portion, the first portion configured to receive lubricant splashed or sprayed by a ring gear and the one or more restrictions being provided in second portion.

4. The axle assembly of claim 1, wherein the one or more restrictions are provided in a portion of the conduit assembly which is disposed within the arm portion.

5. The axle assembly of claim 1, wherein the conduit assembly comprises a first portion and a second portion, the first portion being connected to the second portion via a coupling.

6. The axle assembly of claim 1, wherein the one or more restrictions comprises a plurality of bends.

7. The axle assembly of claim 1, wherein at least one restriction of the one or more restrictions is U-shaped.

8. The axle assembly of claim 1, wherein the conduit assembly comprises an end portion having an end for delivering lubricant to the arm portion.

9. The axle assembly of claim 3, wherein the second portion directs the lubricant through the arm portion such that at least a portion of a flow of lubricant through the second portion is in a direction which is parallel to a direction in which the arm portion extends.

10. The axle assembly of claim 4, wherein the portion of the conduit assembly which is disposed within the arm portion extends from a first side of the arm portion toward a second side of the arm portion.

11. The axle assembly of claim 8, wherein the end defines an opening.

12. The axle assembly of claim 8, wherein the end portion has a curved section which extends in a downward direction.

13. The axle assembly of claim 8, further comprising a cap secured to the end portion, wherein the cap defines an opening.

14. The axle assembly of claim 9, wherein another portion of the flow of lubricant directed through the second portion is in a direction which is perpendicular to the direction in which the arm portion extends.

15. The axle assembly of claim 12, wherein the opening is of a diameter which is less than a diameter of a portion of the end portion.
